(19) United States
(12) Patent Application Publication
(10) Pub. No.: US 2024/0246854 A1
(43) Pub. Date: Jul. 25, 2024

(54) GLASS SUBSTRATE

(71) Applicant: AGC Inc., Tokyo (JP)

(72) Inventors: Mamoru ISOBE, Tokyo (JP); Yuha KOBAYASHI, Tokyo (JP); Izuru SUWA, Tokyo (JP)

(73) Assignee: AGC Inc., Tokyo (JP)

(21) Appl. No.: 18/419,877

(22) Filed: Jan. 23, 2024

(30) Foreign Application Priority Data
Jan. 25, 2023 (JP) 2023-009528
Dec. 5, 2023 (JP) 2023-205458

(51) Int. Cl. C03C 23/00

(52) U.S. Cl. CPC C03C 23/0025

(57) ABSTRACT

A glass substrate is a glass substrate in which a dot is formed on a surface. A region in which the dot is formed does not include a crack, and a retardation in the region in which the dot is formed is equal to or smaller than 50 nm.

### CROSS-REFERENCE TO RELATED APPLICATIONS

The present application claims priority to and incorporates by reference the entire contents of Japanese Patent Application No. 2023-009528 filed in Japan on Jan. 25, 2023, and Japanese Patent Application No. 2023-205458 filed in Japan on Dec. 5, 2023.

### BACKGROUND OF THE INVENTION

### 1. Field of the Invention

The present invention relates to a glass substrate.

### 2. Description of the Related Art

A glass substrate may be used as a member for supporting a semiconductor device during a manufacturing process for a semiconductor device. For example, as illustrated in Patent Literatures 1 and 2, a mark may be formed on a surface of such a glass substrate by irradiating the surface of the glass substrate with laser light to engrave a seal thereon. The related technologies are described, for example, in: WO2018/150759; and Japanese Patent Application Laid-open No. 2019-131462.

However, fragility of the glass substrate is typically high, so that a fracture may be caused by the mark engraved on the surface as a starting point. Thus, there is a demand for suppressing a fracture on the glass substrate on which the mark is formed.

### SUMMARY OF THE INVENTION

It is an object of the present invention to at least partially solve the problems in the conventional technology.

A glass substrate of the present disclosure is a glass substrate in which a dot is formed on a surface, wherein a region in which the dot is formed does not include a crack, and a retardation in the region in which the dot is formed is equal to or smaller than 50 nm.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a glass substrate according to an embodiment;

FIG. 2 is a schematic diagram of an example of a mark;

FIG. 3 is a schematic enlarged view of a portion of the glass substrate where a dot is formed;

FIG. 4 is an A-A cross-sectional view of FIG. 3;

FIG. 5 is a diagram illustrating another example of a shape of the dot;

FIG. 6 is a diagram illustrating another example of the shape of the dot; and

FIG. 7 is a schematic diagram for explaining a four-point bending strength test for the glass substrate.

### DETAILED DESCRIPTION OF THE PREFERRED EMBODIMENTS

The following describes a preferred embodiment of the present invention in detail with reference to the attached drawings. The present invention is not limited to the embodiment, and in a case in which there are a plurality of embodiments, the embodiments may be combined with each other. Numerical values encompass rounded numerical values.

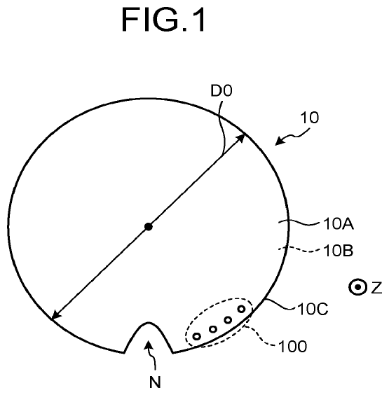

FIG. 1 is a schematic diagram of a glass substrate according to the present embodiment. A glass substrate 10 according to the present embodiment is used as a glass substrate for manufacturing a semiconductor package, and is a glass substrate for supporting a semiconductor device. More specifically, the glass substrate 10 is a support glass substrate for manufacture using a Fan Out Wafer Level Package (FOWLP) technique. For example, in a case in which the glass substrate 10 has a rectangular shape, the glass substrate 10 is a support glass substrate for manufacturing a Fan Out Panel Level Package (FOPLP). However, a use of the glass substrate 10 is not limited to supporting the semiconductor device and manufacturing the FOWLP or the FOPLP, but is optional. The glass substrate 10 may be a glass substrate used for supporting an optional member. Additionally, the glass substrate 10 may be cover glass for an image sensor, or glass or crystallized glass processed to be an optional product such as a substrate for a semiconductor device.

As illustrated in FIG. 1, the glass substrate 10 is a plate-shaped member including a surface 10A (one surface) as a principal plane on one side and a surface 10B (another surface) as a principal plane on the opposite side of the surface 10A. The glass substrate 10 has a disc shape, which is a circular shape, in a plan view, that is, when viewed from a direction orthogonal to the surface 10A. In other words, the glass substrate 10 has a wafer shape. Alternatively, a notch part N may be formed on an outer peripheral surface of the glass substrate 10, and the glass substrate 10 may have a shape obtained by partially notching an outer circumference of the circular shape. However, the shape of the glass substrate 10 is not limited to the disc shape but may be an optional shape. For example, the glass substrate 10 may be a plate having a polygonal shape such as a rectangle. Additionally, the notch part N is not an essential configuration, so that the notch part N is not necessarily formed on the glass substrate 10. Hereinafter, a direction orthogonal to the surface 10A is referred to as a Z-direction. It can also be said that the Z-direction is a thickness direction of the glass substrate 10.

### Diameter of Glass Substrate

A diameter DO of the glass substrate 10 is preferably equal to or larger than 150 mm and equal to or smaller than 700 mm, more preferably equal to or larger than 150 mm and equal to or smaller than 600 mm, and even more preferably equal to or larger than 150 mm and equal to or smaller than 450 mm. By causing the diameter DO to fall within this range, a member such as a semiconductor device can be appropriately supported. The diameter DO indicates a diameter in a case in which the glass substrate 10 has a circular shape. However, in a case in which the glass substrate 10 does not have the circular shape, the diameter DO may indicate a maximum value of a distance between optional two points on an outer peripheral edge of the glass substrate 10.

### Thickness of Glass Substrate

A thickness of the glass substrate 10, that is, a length in the Z-direction between the surface 10A and the surface 10B, is preferably equal to or smaller than 2 mm, more preferably equal to or larger than 0.5 mm and equal to or smaller than 1.8 mm, and even more preferably equal to or larger than 0.6 mm and equal to or smaller than 1.5 mm. If the thickness of the glass substrate 10 exceeds this range, handling thereof is difficult in a semiconductor manufacturing device due to increase of weight. If the thickness is smaller than this range, rigidity at the time of being used as a supporting member becomes low and warpage of the glass and the semiconductor device is increased, which is inappropriate for use of manufacturing a semiconductor device.

### Composition of Glass Substrate

The glass substrate 10 preferably contains the following compounds in mass % (wt %) on an oxide basis. By causing the glass substrate 10 to have the following composition, members can be appropriately supported.
SiO₂: preferably equal to or larger than 40 wt % and equal to or smaller than 75 wt %, and more preferably equal to or larger than 50 wt % and equal to or smaller than 75 wt %.
Al₂O₃: preferably equal to or larger than 0 wt % and equal to or smaller than 20 wt %, and more preferably equal to or larger than 0 wt % and equal to or smaller than 15 wt %.
B₂O₃: preferably equal to or larger than 0 wt % and equal to or smaller than 20 wt %, and more preferably equal to or larger than 0 wt % and equal to or smaller than 10 wt %.
MgO: preferably equal to or larger than 0 wt % and equal to or smaller than 25 wt %.
CaO: preferably equal to or larger than 0 wt % and equal to or smaller than 25 wt %, and more preferably equal to or larger than 0 wt % and equal to or smaller than 15 wt %.
SrO: preferably equal to or larger than 0 wt % and equal to or smaller than 10 wt %.
BaO: preferably equal to or larger than 0 wt, and equal to or smaller than 20 wt %, and more preferably equal to or larger than 0 wt % and equal to or smaller than 15 wt %.
Li₂O: preferably equal to or larger than 0 wt % and equal to or smaller than 40 wt %.
Na₂O: preferably equal to or larger than 0 wt and equal to or smaller than 15 wt %.
K₂O: preferably equal to or larger than 0 wt % and equal to or smaller than 10 wt %.
ZrO₂: preferably equal to or larger than 0 wt % and equal to or smaller than 10 wt %, more preferably equal to or larger than 0 wt % and equal to or smaller than 8 wt %, and even more preferably equal to or larger than 0 wt and equal to or smaller than 5 wt %.
TiO₂: preferably equal to or larger than 0 wt % and equal to or smaller than 5 wt %.
Y₂O₃: preferably equal to or larger than 0 wt % and equal to or smaller than 10 wt %.

### Mark

On the surface 10A of the glass substrate 10, a mark 100 as an engraved seal is formed. The mark 100 may be, for example, an identifier constituted of at least one of a numeral, a character, a two-dimensional code, and a figure. The number of numerals, characters, two-dimensional codes, and figures may be one or multiple. It can be said that the mark 100 as the identifier is a mark for identifying the glass substrate 10. The mark 100 as the identifier can be used for identifying and managing the glass substrate 10, for example.

The mark 100 is not limited to the identifier for identifying the glass substrate 10, but may be an alignment mark, for example. The alignment mark is, for example, a mark for positioning the glass substrate 10, and can be used for aligning a position or a direction of the glass substrate 10 at the time of handling thereof or performing processing such as cutting, chamfering, and bonding thereon. The alignment mark may be a mark for determining orientation of the glass. That is, at the time of laminating a device on the glass substrate, a seal may be engraved on an opposite surface of a surface on which the device is laminated corresponding to variation of warpage at the time of manufacturing the device. As a result, orientation of the warpage of the glass can be determined based on the alignment mark. By engraving a seal on the opposite surface of the surface on which the device is laminated, the identifier of the glass substrate 10 can be recognized even after the device is laminated. The orientation of the warpage is determined based on whether BOW is positive or negative, but may be determined based on a deflection amount and the like of a portion where three points are supported. An article to be bonded to the glass is not limited to the device, but may be a thin film made of metal or organic matter, a semiconductor wafer such as Si, glass, or the like.

Hereinafter, each one of a numeral, a character, and a figure constituting the mark 100 is referred to as a mark element 102. That is, the mark 100 is constituted of a plurality of the mark elements 102. However, the mark 100 may be constituted of one mark element 102.

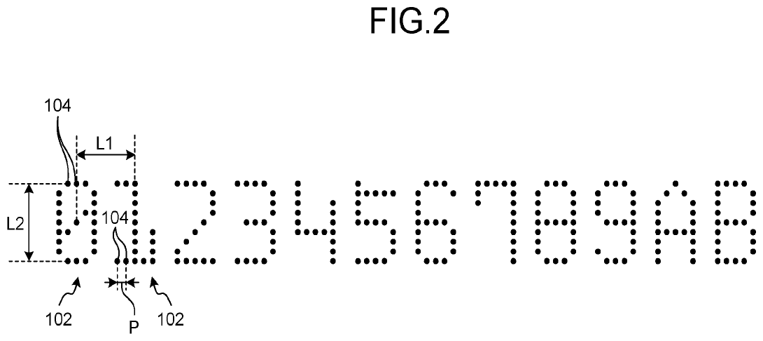

FIG. 2 is a schematic diagram of an example of the mark. In the example of FIG. 2, the mark 100 is illustrated as an identifier constituted of 12 mark elements 102 linearly arranged in a line. However, an aspect of the mark 100 is not limited thereto. For example, the mark 100 may have a configuration in which the mark elements 102 are non-linearly arranged. Alternatively, the mark 100 may have a configuration in which two or more lines of the mark elements 102 are linearly or non-linearly arranged.

Dimensions of the entire mark 100 are not particularly limited. For example, in a case of linear arrangement of the mark elements 102 as illustrated in FIG. 2, a space L1 between characters may fall within a range of 1.420±0.025 mm, and a vertical length L2 may be 1.624±0.025 mm. In a case in which the mark 100 is constituted of the mark elements 102 that are non-linearly arranged, the space L1 between the characters and the vertical length L2 of the mark 100 are respectively defined as, assuming a minimum rectangle including the mark 100, a length of a first side and a length of a second side of the minimum rectangle. The space L1 between the characters is a distance between the center of the mark element 102 and the center of the mark element 102 that is adjacent to the former mark element 102 in a lateral direction, and the vertical length L2 indicates a distance in a vertical direction between the center of a dot 104 closest to one side in the vertical direction of the mark element 10′2 and the center of the dot 104 closest to another side in the vertical direction.

The mark element 102 (mark 100) is constituted of a plurality of the dots 104. In other words, one mark element 102 or mark 100 is formed of the dots 104. In the present embodiment, the dots 104 do not overlap with each other, and are formed to be separated from each other. A pitch P between the adjacent dots 104 is defined by SEMI AUX015-1106 SEMI OCR CHARACTER OUTLINES or SEMI-T7-0303, and defined based on types of a font and a two-dimensional code. The pitch P indicates a distance between the center of one dot 104 and the center of the dot 104 adjacent to the former dot 104 in a direction along the surface 10A.

The dot 104 is made by machining such as laser machining or sand blasting, chemical etching, printing, and the like. Particularly, in a case of being manufactured by laser machining, the mark element 102 is constituted of a plurality of laser irradiation traces. A size of the laser irradiation trace or a pitch between the irradiation traces is determined based on a configuration of an optical system of a laser machining device.

### Dot

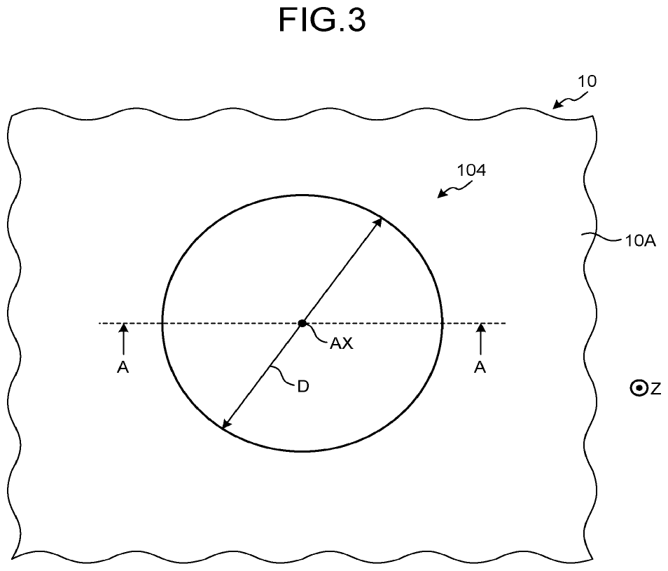

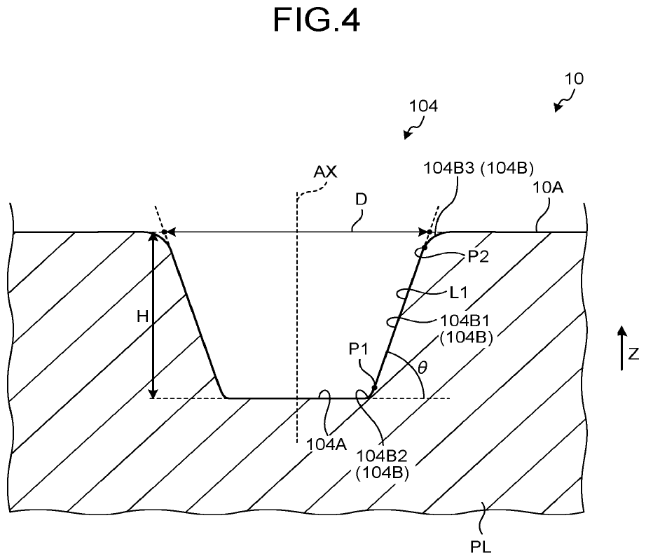

FIG. 3 is a schematic enlarged view of a portion of the glass substrate where the dot is formed, and FIG. 4 is an A-A cross-sectional view of FIG. 3. It can be said that FIG. 4 is a cross-sectional view of the glass substrate 10 assuming that a cross section is a plane PL passing through the center of the dot 104 and extending along the Z-direction. The dot 104 indicates an indentation formed on the surface 10A of the glass substrate 10. However, a dot shape is not necessarily an indentation shape, that is, a concave shape. For example, the dot shape is a convex shape in a case of being formed by printing, and in a case in which the dot is formed by sand blasting and the like, surface roughness of a corresponding point is increased and visibility of the mark is improved. In the present embodiment, the dot 104 is formed by irradiating the surface 10A with laser light. That is, it can be said that the dot 104 in the present embodiment is a laser irradiation trace (irradiation trace of laser light). One dot 104 may be formed of a plurality of laser irradiation traces, or may be formed of one laser irradiation trace. The laser light may be emitted to the same point multiple times to cause a depth of the dot after the machining to be easily read, or may be emitted while being shifted at a fixed pitch to form the dot. One laser irradiation trace indicates an irradiation trace formed by one shot of laser light. That is, the dot 104 may be formed by laser light emitted in one period from when the laser light is output until it is stopped, or may be formed by a plurality of laser irradiation traces. That is, the dot 104 may be formed by laser light that has been intermittently emitted over a plurality of periods.

It is preferable that the dot 104 is formed at a position separated inward in a radial direction from an end face 10C of the glass substrate 10 within 20 mm therefrom. The radial direction herein means a radial direction assuming that an axis passing through the center of the glass substrate 10 along the Z-direction is a center axis. The end face 10C of the glass substrate 10 means a surface (side surface) connecting the surface 10A and the surface 10B of the glass substrate 10.

### Shape of Dot

As illustrated in FIG. 3, the dot 104 has a circular shape when viewed from the Z-direction. However, the shape of the dot 104 when viewed from the Z-direction is not limited to the circular shape. For example, the dot 104 may have an elliptic shape or the like when viewed from the Z-direction. Alternatively, the shape of the dot 104 may be a ring, a rectangle, a double circle, an imperfect circle such as a character “C”, or a spiral shape obtained by combining a plurality of laser irradiation traces.

As illustrated in FIG. 4, the dot 104 includes a bottom surface 104A and a side surface 104B. The bottom surface 104A indicates a bottom portion of the dot 104, and the side surface 104B indicates a side surface portion connecting the bottom surface 104A of the dot 104 and the surface 10A of the glass substrate 10. The side surface 104B includes a side surface part 104B1, a connection part 104B2, and a connection part 104B3. The side surface part 104B1 is a portion forming the side surface of the dot 104. The connection part 104B2 is a portion formed at an end part of the side surface part 104B1 on the opposite side of the Z-direction, and has an R-shape connecting the bottom surface 104A and the side surface part 104B1. The connection part 104B3 is a portion formed at an end part of the side surface part 104B1 on the Z-direction side, and has an R-shape connecting the side surface part 104B1 and the surface 10A of the glass substrate 10. However, the side surface 104B does not necessarily include the connection parts 104B2 and 104B3 each having the R-shape. A connecting portion between the bottom surface 104A and the side surface part 104B1 and a connecting portion between the side surface part 104B1 and the surface 10A of the glass substrate 10 may have an edge shape (angular shape).

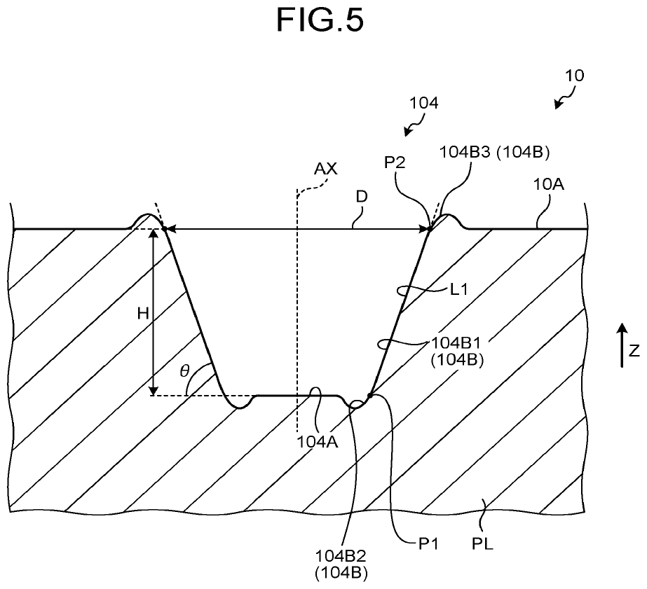

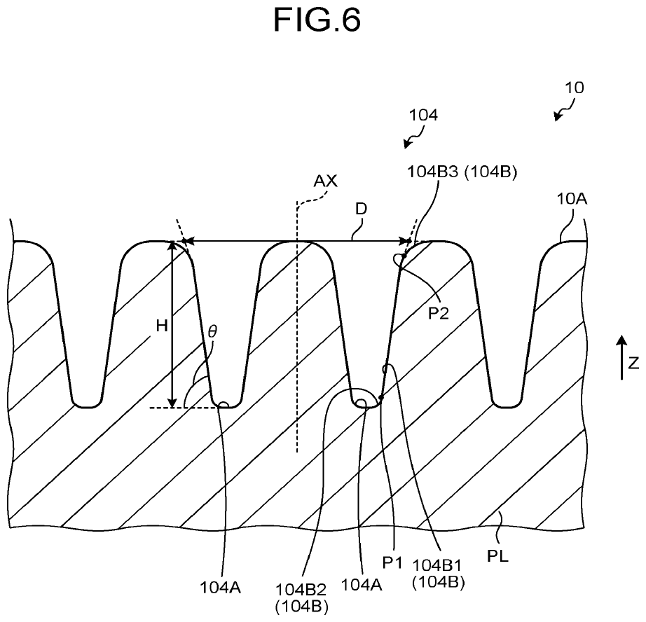

FIG. 5 and FIG. 6 are diagrams illustrating other examples of the shape of the dot 104. As illustrated in FIG. 5, a bulge may be generated in the vicinity of the side surface 104B on the surface 10A side in accordance with quality of the glass and quality of laser machining. Assuming that a center axis AX of the dot 104 along the Z-direction is an axial direction, it can be said that the bulge in the vicinity of the side surface 104B is a projecting part that is formed on an outer side in the radial direction than the dot 104 along the outer circumference of the dot 104 on the surface 10A. Additionally, a depression may be generated in the vicinity of the side surface 104B on the bottom surface 104A side. It can be said that the indentation in the vicinity of the side surface 104B is a recessed part (groove) that is formed on an inner side in the radial direction than the side surface part 104B1 of the dot 104 along the outer circumference of the dot 104 on the bottom surface 104A. Such a bulge or depression is preferably smaller than 50% of a depth H of the dot 104 in the Z-direction, and more preferably smaller than 25% thereof. The bulge or depression preferably expands in a range equal to or smaller than 50% of a diameter D of the dot 104 in the radial direction of the dot 104, and more preferably expands in a range equal to or smaller than 25% thereof. That is, a width of the bulge or depression (a length of the bulge or depression in the radial direction of the dot 104) is preferably equal to or smaller than 50% of the diameter D, and more preferably equal to or smaller than 25% of the diameter D. When the bulge or depression falls within this range, ease of reading can be secured. Particularly, the bulge is preferably small to be negligible, and chemical processing with a medical fluid such as hydrofluoric acid or mechanical polishing processing using a polishing material or a polishing pad may be performed to remove the bulge after laser machining. Regarding the bulge, only a portion around the dot may be locally processed, or the entire substrate may be uniformly processed. Surface roughness of a processed region in a case in which the bulge is removed is preferably equivalent to that of the entire substrate, but the surface roughness around the engraved seal may be reduced to reduce scattering of irradiation light from a reader and achieve easy reading. As illustrated in FIG. 6, in a case in which visibility cannot be secured with one circular shape, a mark shape such as a double circle may be employed. In any case, a steep change of the shape is minimized to avoid concentration of stress and keep high strength of the glass substrate.

### Diameter of Dot

The diameter D of the dot 104 is preferably equal to or larger than 50 μm and equal to or smaller than 200 μm, more preferably equal to or larger than 80 μm and equal to or smaller than 150 μm, and even more preferably equal to or larger than 90 μm and equal to or smaller than 120 μm. By causing the diameter of the dot 104 to fall within this range, the size of one dot 104 can be relatively large, and the mark 100 can be appropriately visually recognized. As illustrated in FIG. 4, the diameter D of the dot 104 may indicate a diameter of a virtual circle that is formed by a curved surface along the side surface part 104B1 (corresponding to a side surface of a truncated cone) and a plane along the surface 10A intersecting with each other. In a case in which the dot 104 does not have a circular shape, the diameter D may be the longest distance between two points on an outer circumference of a virtual region formed by the surface along the side surface part 104B1 and the plane along the surface 10A intersecting with each other.

### Depth of Dot

The depth H of the dot 104 is preferably equal to or larger than 0.5 μm and equal to or smaller than 7.0 μm, more preferably equal to or larger than 0.5 μm and equal to or smaller than 5.0 μm, and even more preferably equal to or larger than 0.5 μm and equal to or smaller than 3.0 μm. By causing the depth H to fall within this range, a fracture of the glass substrate 10 starting from the dot 104 can be suppressed, and ease of reading can be secured. The depth H indicates a distance between the surface 10A and the bottom surface 104A in the Z-direction.

The depth H of the dot 104 is measured by the following method. Regarding the dots of the mark, a cross-sectional shape of an optional dot is measured by the laser microscope described above. Subsequently, the lowest point of the cross section is assumed to be S, and a difference between the surface 10A as a glass main surface and the lowest point S in the Z-direction is assumed to be the depth H. However, in a case of a form having a concave shape on a dot outer peripheral part as illustrated in FIG. 5, the depression of the dot outer peripheral part does not need to be taken into account as the lowest point. The depth H can be measured by OLS4000 manufactured by Olympus Corporation.

Assuming that ΔH indicates a deviation of the depth of the bottom surface part excluding a depression generated on a radially inner side of the bottom surface, MH is preferably equal to or smaller than 50% of the depth H, and more preferably equal to or smaller than 25% thereof.

### Surface Roughness of Bottom Surface of Dot

Arithmetic average roughness Ra defined in JIS B 0601:2001 of the bottom surface 104A of the dot 104 is preferably equal to or smaller than 0.1 μm, more preferably equal to or larger than 0.01 μm and equal to or smaller than 0.1 μm, and even more preferably equal to or larger than 0.01 μm and equal to or smaller than 0.05 μm. A maximum height Rz defined in JIS B 0601:2001 of the bottom surface 104A of the dot 104 is preferably equal to or smaller than 1 μm, and more preferably equal to or larger than 0.01 μm and equal to or smaller than 0.5 μm. By causing the surface roughness of the bottom surface 104A to fall within this range, it is possible to prevent a fracture of the substrate starting from a minute crack of an engraved seal part, and easy reading of the engraved seal can be achieved. If the surface roughness exceeds this range, a fracture stress of the engraved seal part may be lowered because a minute crack is latent, and a fracture of the glass substrate starting from the engraved seal may be caused. On the other hand, if the surface roughness is smaller than this range, reference light for reading the engraved seal cannot be preferably scattered and reflected, and reading of the engraved seal may be failed. The arithmetic average roughness Ra and the maximum height Rz are calculated by extracting a reference length. The reference length may be 30 μm, for example. The arithmetic average roughness Ra and the maximum height Rz can be measured by OLS4000 manufactured by Olympus Corporation. In the measurement, a magnification of an object lens is 50 times.

### Surface Roughness of Side Surface Part of Dot

The arithmetic average roughness Ra defined in JIS B 0601:2001 of the side surface part 104B1 of the dot 104 is preferably equal to or smaller than 1 μm, more preferably equal to or smaller than 0.1 μm, and even more preferably equal to or larger than 0.01 μm and equal to or smaller than 0.05 μm. By causing the surface roughness of the side surface part 104B1 to fall within this range, even in a case of reducing the depth H of the dot 104 as in the range described above, light can be appropriately reflected, and visibility of the mark 100 can be prevented from being lowered. The arithmetic average roughness Ra of the side surface part 104B1 is calculated by extracting a reference length of roughness curve of the side surface part 104B1. The reference length may be 30 μm, for example.

### Inclination Angle of Side Surface of Dot

The diameter of the dot 104 may be reduced as being closer to the bottom surface 104A. In this case, an inclination angle θ of the side surface 104B of the dot 104 is preferably equal to or larger than 5° and equal to or smaller than 56°, more preferably equal to or larger than 5° and equal to or smaller than 55°, and even more preferably equal to or larger than 15° and equal to or smaller than 55°. By causing the inclination angle θ to fall within this range, even in a case of reducing the depth H of the dot 104 as in the range described above, light can be appropriately reflected, and the visibility of the mark 100 can be prevented from being lowered. If the inclination angle θ exceeds this range, a reflection area is reduced with respect to incident of light source for reading the mark from the main surface side, so that reading is made difficult. The inclination angle θ indicates an angle formed by the bottom surface 104A and the side surface 104B of the dot 104, and it can be said that the inclination angle θ is a gradient of the dot 104. It can also be said that the inclination angle θ is an angle formed by the bottom surface 104A and a line segment LI passing through the side surface part 104B1 and running along the plane PL. More specifically, it can be said that the line segment LI is a straight line passing through a position P1 and a position P2 of the side surface 104B, and running along the plane PL. The position P1 indicates a position that is distant from the bottom surface 104A toward the Z-direction side by a distance of 20% of the depth H, and the position P2 indicates a position on the side surface 104B that is distant from the bottom surface 104A toward the Z-direction side by a distance of 80% of the depth H. In the example of FIG. 4, the position P1 is a boundary portion between the side surface part 104B1 and the connection part 104B2, and the position P2 is a boundary portion between the side surface part 104B1 and the connection part 104B3.

### Crack

A region in which the dot 104 is formed on the surface 10A of the glass substrate 10 does not include a crack. The region in which the dot 104 is formed on the surface 10A of the glass substrate 10 may include a boundary portion between the region in which the dot 104 is formed and the region in which the dot 104 is not formed. For example, the region in which the dot 104 is formed on the surface 10A may indicate the bottom surface 104A of the dot 104, the side surface 104B of the dot 104, and the connecting portion between the side surface part 104B1 and the surface 10A.

A crack is not formed in the region in which the dot 104 is formed, so that a fracture of the glass substrate 10 starting from the dot 104 (mark 100) can be suppressed.

The fact that no crack is formed can be checked by microscopic observation. In the microscopic observation, the region in which the dot 104 is formed is observed by a microscope MX50 manufactured by Olympus Corporation at 20-fold magnification to detect presence/absence of a crack in the region in which the dot 104 is formed. In a case in which a crack is present, a length of the crack is measured. In this measurement, it is determined that a crack is not formed in a case in which there is no crack starting from the dot 104 and having a length of 10 μm or more, and it is determined that a crack is formed in a case in which there is a crack starting from the dot 104 and having a length of 10 μm or more.

### Retardation

A retardation in the region in which the dot 104 is formed on the surface 10A of the glass substrate 10 is equal to or smaller than 50 nm, preferably equal to or larger than 5 nm and equal to or smaller than 50 nm, and more preferably equal to or larger than 5 nm and equal to or smaller than 20 nm.

In a case of forming a dot on the surface 10A of the glass substrate 10 by machining with laser light and the like, a value of retardation may be increased due to a residual stress and the like. As the value of retardation becomes higher, a fracture is more easily caused. On the other hand, the glass substrate 10 in the present embodiment can suppress a fracture as the retardation is equal to or smaller than 50 nm. Additionally, for example, the retardation can be lowered by lowering processing intensity (for example, intensity of laser light), but when the retardation is lowered, working time for forming a dot having a desired depth is prolonged. On the other hand, while the glass substrate 10 in the present embodiment can prevent a fracture by causing the retardation not to be excessive with the retardation equal to or larger than 5 nm and equal to or smaller than 50 nm, the working time can be prevented from being excessively increased by increasing the processing intensity to some degree while allowing a certain value of the retardation. That is, by causing the depth of the dot 104 to fall within the range described above and causing the retardation to fall within this range, the depth of the dot 104 can be caused to be sufficiently deep to suppress lowering of the visibility, a fracture can be suppressed, and the working time can be shortened.

The retardation can be measured under a condition of magnification of 20 times by using WPA micro manufactured by Photonic Lattice, Inc.

### Four-Point Bending Strength

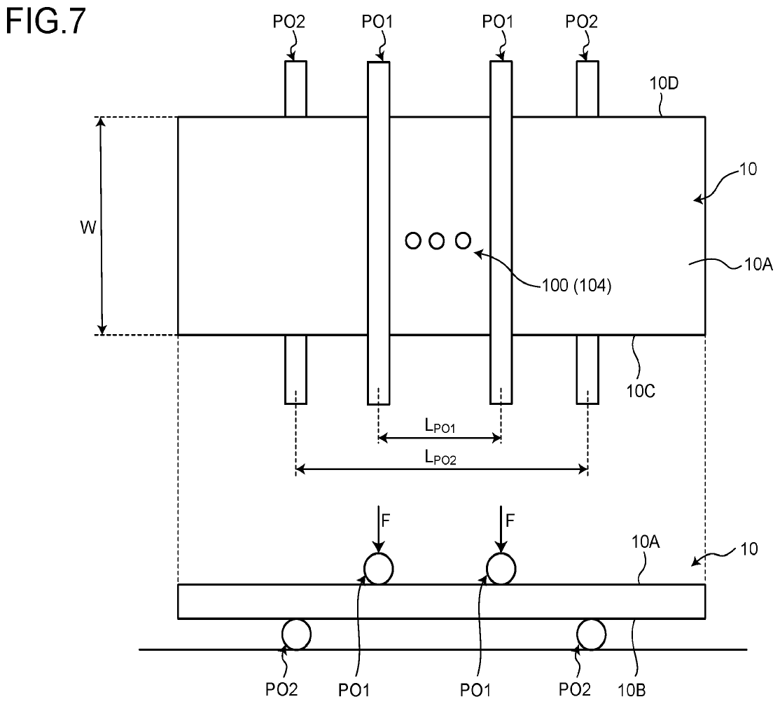

FIG. 7 is a schematic diagram for explaining a four-point bending strength test for the glass substrate. As illustrated in FIG. 7, the four-point bending strength test for the glass substrate 10 is performed by cutting the glass substrate 10 at a cut surface 10D so that a distance W from the end face 10C in the vertical direction along the surface 10A is 20 mm. That is, it can be said that the glass substrate 10 in this test is a portion from the end face 10C to the cut surface 10D.

In this test, two cylindrical shaft members PO1 are arranged to be adjacent to each other across the mark 100 (dot 104) on the surface 10A of the glass substrate 10, and two cylindrical shaft members PO2 are arranged on outer sides than the two shaft members PO1 (sides farther from the mark 100) on the surface 10B. That is, the two shaft members PO2 are adjacent to each other across the two shaft members PO1. A distance L_{PO1} between the shaft members PO1 is assumed to be 30 mm, and a distance L_{PO2} between the shaft members PO2 is assumed to be 60 mm.

In this test, the surface 10B is oriented downward in the vertical direction in this state, and the surface 10B is grounded via the two shaft members PO2. A load is applied downward in the vertical direction to the two shaft members PO1 while causing the two shaft members PO1 to be in contact with the surface 10A, and the load at the time when the glass substrate 10 is fractured is measured as a load F.

The following describes determination of how the glass substrate 10 is fractured in this test. In this test, at the time when the glass substrate 10 is fractured, in a case in which the glass substrate 10 is fractured with a fracture starting point on the outer side of the two shaft members PO1, the glass substrate 10 is not fractured in a load range (between the two shaft members PO1), so that it is determined that the glass substrate 10 is not effectively fractured (ineffective as test data). Even in a case in which the glass substrate 10 is fractured with a fracture starting point on an inner side of the two shaft members PO1, it is determined that the glass substrate 10 is not effectively fractured (ineffective as test data) in a case in which the fracture starting point is present on the cut surface 10D. This is because the cut surface 10D is not present on the original glass substrate (10 in FIG. 1) and does not reflect fracture strength of the original glass substrate.

As a testing device for this test, Autograph AGS-5kNJ manufactured by Shimadzu Corporation may be used. Each diameter of the shaft members PO1 and PO2 is 10 mm, and stainless steel is used as a material therefor.

Herein, a four-point bending strength a of the glass substrate 10 is assumed to be expressed by the following expression (1). In the expression (1), t indicates a thickness (mm) of the glass substrate 10.

σ=3F(L_{PO2}−L_{PO1})/(2Wt²) (1)

In this case, the four-point bending strength a of the glass substrate 10 is preferably equal to or larger than 110 MPa, and more preferably equal to or larger than 150 MPa. By causing the four-point bending strength σ to fall within this range, a fracture of the glass substrate 10 can be suppressed. It can be said that the four-point bending strength a of the glass substrate 10 satisfies the range described above with any thickness and any material of the glass substrate 10 so long as there is no crack in the region in which the dot 104 is formed and the retardation is equal to or smaller than 50 nm. The four-point bending strength a herein may indicate an average value of four-point bending strengths a of a plurality of (for example, 10 or more) samples.

### Method for Manufacturing Glass Substrate

A method for manufacturing the glass substrate 10 in the present embodiment includes: a preparation step of preparing a glass plate as the glass substrate before the mark 100 is formed; and an irradiation step of irradiating the surface of the glass substrate with laser light to form the mark 100, and manufacturing the glass substrate 10. At the preparation step, the glass plate is manufactured by causing a glass raw material to be in a glass state by an optional glass melting and molding method such as a float method, a fusion method, or ingot forming method, and the glass plate is processed to have the shape of the glass substrate thereafter. In the example of the present embodiment, the glass substrate has a disc shape, so that the glass is cut out in a circular shape by optional means such as slicing and circular shape cutting, for example, to form the glass plate having a circular shape. The glass plate cut out in the circular shape is subjected to chamfering processing for an end face and grinding and polishing processing for a surface, and the preparation step is completed after a cleaning and inspecting step is performed. At the irradiation step, processing of forming the dot 104 by irradiating the surface of the glass plate with laser light is repeatedly performed to form the mark 100 constituted of a plurality of the dots 104 on the surface of the glass plate.

At the irradiation step, the dot 104 is formed by irradiating the glass surface with laser light. For example, by using a light source having a wavelength of 193 nm, the laser light is emitted to the glass surface via various optical appliances from the light source. A spot diameter may be adjusted by an optical system so that a dot diameter is about 100 μm. The glass surface is moved in an xy-direction by using a scanner, but an xy stage or the like may be used.

### Effects

As described above, in the glass substrate 10 according to a first aspect of the present embodiment, the dot 104 is formed on the surface 10A, the region in which the dot 104 is formed does not include a crack, and the retardation in the region in which the dot 104 is formed is equal to or smaller than 50 nm. According to the present disclosure, the region in which the dot 104 is formed does not include a crack, and the retardation is equal to or smaller than 50 nm, so that a fracture can be suppressed.

The glass substrate 10 according to a second aspect of the present disclosure is the glass substrate according to the first aspect, and the depth of the dot 104 is preferably equal to or larger than 0.5 μm and equal to or smaller than 7.0 μm. By forming the dot 104 having such a depth, lowering of the visibility of the dot 104 (mark 100) can be suppressed while suppressing a fracture.

The glass substrate 10 according to a third aspect of the present disclosure is the glass substrate according to the first aspect or the second aspect, and the retardation in the region in which the dot 104 is formed is preferably equal to or larger than 5 nm and equal to or smaller than 50 nm. By causing the retardation to fall within this range, a fracture can be suppressed and the working time can be shortened at the same time.

The glass substrate 10 according to a fourth aspect of the present disclosure is the glass substrate according to any one of the first aspect to the third aspect, the dot 104 is preferably formed at a position within 20 mm from the end face 10C of the glass substrate 10, and the four-point bending strength a of the glass substrate 10 is preferably equal to or larger than 110 MPa. By causing the four-point bending strength a to fall within this range, a fracture can be appropriately suppressed.

The glass substrate 10 according to a fifth aspect of the present disclosure is the glass substrate according to any one of the first aspect to the fourth aspect, and the diameter of the dot 104 is preferably equal to or larger than 50 μm and equal to or smaller than 200 μm. By causing the diameter of the dot 104 to fall within this range, lowering of the visibility can be suppressed.

The glass substrate 10 according to a sixth aspect of the present disclosure is the glass substrate according to any one of the first aspect to the fifth aspect, and the glass substrate 10 preferably has a circular shape or a rectangular shape. By causing the glass substrate 10 to have this shape, the semiconductor device can be appropriately supported.

The glass substrate 10 according to a seventh aspect of the present disclosure is the glass substrate according to any one of the first aspect to the sixth aspect, and the glass substrate 10 is preferably used as the glass substrate supporting the semiconductor device. A fracture can be suppressed with the glass substrate 10, so that it is preferable as the glass substrate for supporting the semiconductor device.

### EXAMPLES

Next, the following describes examples. Table 1 is a table indicating the examples.

TABLE 1

| | | Example | Example | Example | Example | Example |
|---|---|---|---|---|---|---|
| | | 1 | 2 | 3 | 4 | 5 |
| Depth of dot (μm) | | 0.9 | 2.0 | 3.3 | 3.1 | 7.7 |
| Retardation (nm) | | 11 | 15 | 16 | 3 | — |
| Presence/absence of crack | | Absent | Absent | Absent | Absent | Present |
| Four-point | Number of | 9/10 | 5/10 | 10/10 | 6/11 | 7/13 |
| bending | effective | | | | | |
| strength | fractures/number | | | | | |
| σ | of evaluations | | | | | |
| | Average value | 153 | 152 | 149 | 143 | 109 |
| | (MPa) | | | | | |
| | Maximum value | 164 | 160 | 163 | 156 | 130 |
| | (MPa) | | | | | |
| | Minimum value | 128 | 139 | 119 | 115 | 70 |
| | (MPa) | | | | | |

### Example 1

In the example 1, as the glass substrate, FL960 manufactured by AGC Inc. having a size of 515 mm×510 mm and thickness of 1.8 mm was prepared. In accordance with standards of SEMI AUX015-1106 SEMI OCR CHARACTER OUTLINES and SEMI-T7-0303, the mark 100 constituted of the dots 104 was formed. The dots 104 were formed by emitting ArF laser light having a wavelength of 193 nm multiple times. In the example 1, the diameter of the dot 104 was 100 μm, and the depth of the dot 104 was 0.9 μm.

For the glass substrate in the example 1, the retardation and presence/absence of a crack was measured. A method for measuring the retardation and a method for measuring presence/absence of a crack are the same as the methods described in the present embodiment.

The glass substrate of the example 1 was cut at the cut surface 10D so that the distance W from the end face 10C was 20 mm (refer to FIG. 7). The four-point bending strength a was then measured by using the same method as the four-point bending strength test described in the present embodiment.

Table 1 indicates measurement results of a value of retardation, presence/absence of a crack, and the four-point bending strength a. The value of retardation indicated by Table 1 is a maximum value of the retardation at each position in the region in which the dot 104 is formed. In Table 1, “number of effective fractures/number of evaluations” is “number of samples fractured from the dot 104 or the end face 10C as a starting point in the four-point bending strength test/number of all samples for which the four-point bending strength test is performed”. That is, in the example 1, the four-point bending strength test was performed for ten glass substrates of the example 1, and nine of them were fractured from the dot 104 or the end face 10C as a starting point. In Table 1, an average value of the four-point bending strength a indicates an average value of the four-point bending strength a of effective samples, a maximum value of the four-point bending strength a indicates a maximum value of the four-point bending strength a of the effective samples, and a minimum value of the four-point bending strength a indicates a minimum value of the four-point bending strength a of the effective samples.

### Example 2 and Example 3

In the example 2 and the example 3, the glass substrate was obtained by using the same method as that in the example 1 except that the depth of the dot 104 was set to be 2.0 μm and 3.3 μm. The measurement results of the value of retardation, presence/absence of a crack, and the four-point bending strength a are indicated by Table 1.

### Example 4

In the example 4, the glass substrate was obtained by using the same method as that in the example 1 except that power of the laser light was set to be 1 mJ (¼ of the example 1 to the example 3), and the depth of the dot 104 was set to be 3.1 μm. The measurement results of the value of retardation, presence/absence of a crack, and the four-point bending strength a are indicated by Table 1.

### Example 5

In the example 5, the glass substrate was obtained by using the same method as that in the example 1 except that the glass substrate was caused to have a disc shape having a diameter of 300 mm and a thickness of 0.8 mm, Green laser having a wavelength of 532 nm was used as the laser light, and the dot 104 having a ring shape the outer circumference diameter of which is 100 μm and a depth of 7.7 μm was formed. The measurement results of presence/absence of a crack and the four-point bending strength a are indicated by Table 1.

As indicated by Table 1, in the example 1 to the example 4 as the examples, the retardation is equal to or smaller than 50 nm, and there is no crack. In the example 1 to the example 4, the four-point bending strength a is equal to or larger than 110 MPa, so that it is found that a fracture can be sufficiently suppressed. On the other hand, in the example 5 as a comparative example, there is a crack and the four-point bending strength a is smaller than 110 MPa, so that it is found that a fracture cannot be sufficiently suppressed.

In the examples 1 to 3 in which the retardation is equal to or larger than 5 nm, machining time was shortened as compared with the example 4 in which the retardation is smaller than 5 nm.

According to the present disclosure, a fracture of the glass substrate can be suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A glass substrate in which a dot is formed on a surface, wherein
a region in which the dot is formed does not include a crack, and
a retardation in the region in which the dot is formed is equal to or smaller than 50 nm.

2. The glass substrate according to claim 1, wherein a depth of the dot is equal to or larger than 0.5 μm and equal to or smaller than 7.0 μm.

3. The glass substrate according to claim 1, wherein the retardation in the region in which the dot is formed is equal to or larger than 5 nm and equal to or smaller than 50 nm.

4. The glass substrate according to claim 1, wherein
the dot is formed at a position within 20 mm from an end face of the glass substrate, and
a four-point bending strength of the glass substrate is equal to or larger than 110 MPa.

5. The glass substrate according to claim 1, wherein a diameter of the dot is equal to or larger than 50 μm and equal to or smaller than 200 μm.

6. The glass substrate according to claim 1, having a circular shape or a rectangular shape.

7. The glass substrate according to claim 1, used as a glass substrate for supporting a semiconductor device.
